(19) United States
(12) Patent Application Publication
(10) Pub. No.: US 2011/0013692 A1
(43) Pub. Date: Jan. 20, 2011

(54) Adaptive Video Transcoding

(76) Inventors: Robert A. Cohen, Somerville, MA (US); Anthony Vetro, Arlington, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/413,583

(22) Filed: Mar. 29, 2009

(51) Int. Cl. H04N 7/26; H04N 7/30; H04N 7/32

(52) U.S. Cl. 375/240.02; 375/240.21; 375/240.2; 375/240.12; 375/E07.026

(57) ABSTRACT

Embodiments of the invention describe a method for transcoding an input video in a first encoded format to an output video in a second encoded format, wherein the videos include a set of segments and each segment includes frames. First, the method is determining a set of downsample resilient segments in the input video and a set of full-resolution segments in the input video. Next, the method is downsampling the set of downsample resilient segments to produce a set of downsampled segments and transcoding the input video using the set of full-resolution segments and the set of downsampled segments to produce the output video including at least two segments with different resolutions.

### FIELD OF THE INVENTION

The invention relates generally to video processing, and more particularly to adaptive video transcoding.

### BACKGROUND OF THE INVENTION

Transcoding is the digital-to-digital conversion of one encoded video to another encoded video. Video transcoding methods convert a digital video, i.e., a bitstream, from a first encoded format to a second encoded format. The second format can provide additional benefits, such as reduced storage and transmission requirements. For example, a video recorder can use the video transcoding to convert a video in the MPEG-2 format to the H.264/AVC format, to take advantage of the improved compression efficiency of the H.264/AVC format.

Typically, a transcoder includes a decoder connected to an encoder. For example, an MPEG-2 decoder connected to a H.264/AVC encoder forms a reference transcoder. The reference transcoder is computationally complex due to the need to perform motion estimation in the H.264/AVC encoder. The complexity of the reference transcoder can be reduced by reusing motion and mode information from the input MPEG-2 video bitstream. However, the reuse of such information in the most cost-effective and useful manner is a known problem.

To reduce the complexity of a reference MPEG-2-to-H.264/AVC transcoder, methods such as mapping motion vectors or reducing the resolution, i.e., downsampling, during transcoding have been described.

In a conventional video transcoder, video data are typically transformed, in part, by a quantizer. A fine quantizer produce high-quality compressed video with a large bit-rate or storage requirement. A coarse quantizer produce low-quality compressed video with reduced storage requirements.

The encoder or the transcoder performance can be improved for a given bit-rate by reducing a resolution of a frame of a video before transcoding operations, followed by increasing the resolution after decoding that encoded video. Because the resolution of the video has been reduced, a finer quantizer can be used for a given bit-rate.

However, the trade-off between resolution and quantizer noise sometimes leads to a reduction in video quality. Fine details in the video can be blurred by downsampling to such an extent that after being decoded and upsampled, visible artifacts appear in the video, even when a very fine quantizer has been used.

Conventional transcoding methods either reduce resolution of a video before the transcoding operation, which decreases the quality of subsequently decoded video, or encode full resolution video, which increases the complexity of the transcoding operations.

It is desired to reduce the complexity of the transcoding video operation without decreasing the quality of a subsequently decoded video.

### SUMMARY OF THE INVENTION

It is an object of the invention to provide a method for reducing a complexity of a video transcoding without decreasing a quality of a subsequently decoded video.

It is a further object of the invention to provide a method that enables switching adaptively between full and reduced-resolution transcoding, based on the content of the video.

The embodiments of the invention are based on a realization that different segments of the video have different sensitivity to the downsampling operation than other segments of the same video. Thus, by downsampling, before the transcoding, only resilient to downsampling segments of the video, the complexity of the video transcoding overall is reduced without decreasing the quality of subsequently decoded and upsampled video. Moreover, the resilient to downsampling segments of the video are selected based on content of the video itself, enabling adaptive switching between full and reduced-resolution transcoding based on the content of the video.

One embodiment of the invention describes a method for transcoding an input video in a first encoded format to an output video in a second encoded format, wherein the videos include a set of segments and each segment includes frames, comprising a processor for performing steps of the method, comprising the steps of: determining a set of downsample resilient segments in the input video; determining a set of full-resolution segments in the input video; downsampling the set of downsample resilient segments to produce a set of downsampled segments; and transcoding the input video using the set of full-resolution segments and the set of downsampled segments to produce the output video including at least two segments with different resolutions.

Another embodiment describes an adaptive video transcoder, comprising: an adaptive resolution selector configured to determine a set of downsample resilient segments and a set of full-resolution segments in an input video; a downsampling module configured to downsample the set of downsample resilient segments to produce a set of downsampled segments; and a transcoding module configured to transcode the input video using the set of downsampled segments and the set of full-resolution segments to produce a output video having at least two segments of different resolution.

Yet another embodiment describes a method for adaptive video transcoding of an input video in a first encoded format into an output video in a second encoded format, wherein each segment of the input video has a constant resolution, comprising a processor for performing steps of the method, comprising the steps of: determining a set of downsample resilient segments in the input video; and transcoding the input video into the output video, such that a resolution of only the set of downsample resilient segments in the output video is reduced.

### BRIEF DESCRIPTION OF THE DRAWINGS

FIG. 1 is a block diagram of a method and a system for adaptively transcoding a video based on a content of the video according to embodiments of an invention;

FIG. 2 is a block diagram a method for adaptively transcoding a video based on quality metrics of a full-resolution video according an embodiment of the invention;

FIG. 3 is a block diagram a method for adaptively transcoding a video based on bitstream information according an embodiment of the invention;

FIG. 4 is a block diagram of an adaptive-resolution transcoder according to an embodiment of the invention;

FIG. 5 is a block diagram of an adaptive-resolution transcoder based on quality metrics according to an embodiment of the invention; and

FIG. 6 is a block diagram of an adaptive-resolution transcoder based on compressed data according to an embodiment of the invention.

### DESCRIPTION OF THE INVENTION

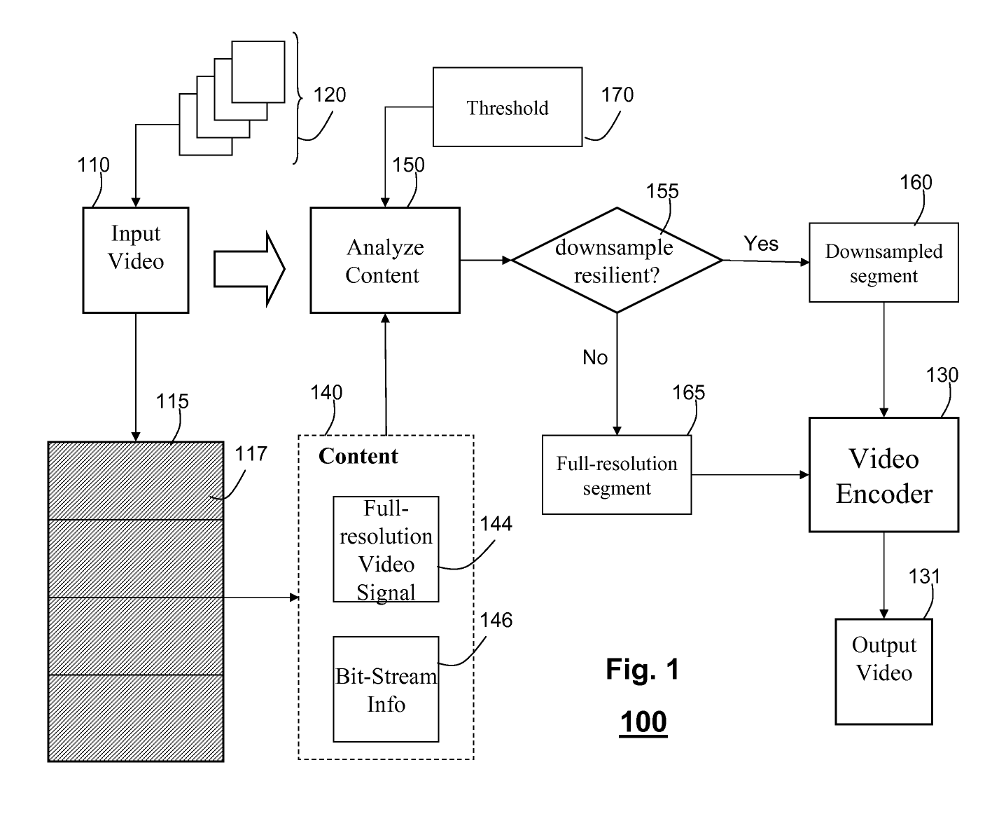

FIG. 1 shows a method and a system 100 for adaptively transcoding 100 an input video 110 to produce an output video 131 according to embodiments of our invention. The transcoding is based on a content of the video. The video includes frames 120. The video 110 is partitioned into a set of segments 115, e.g., a segment 117. The segment 117 can include one or more frames 120.

The content 140 of the segment 117 of the video is analyzed 150 and compared to a predetermined threshold 170 to determine if that segment is downsample resilient 155.

As defined herein, for the purpose of this specification and appended claims, a downsample resilient segment of a video is a segment, which after being downsampled and transcoded can be decoded and upsampled to a decoded segment, such that a resolution and a quality of the decoded segment are substantially equal to a resolution and a quality of the downsample resilient segment before downsampling and transcoding.

If the segment 117 is the downsample resilient segment, a downsampled version 160 of the segment 117 is sent to an encoder 130. Otherwise, a full resolution version 165 of the segment 117 is sent to the encoder 130. The method 100 is repeated for all segments 117 of the video.

We transcode the input video using a set of full-resolution segments and a set of downsampled segments to produce an output video in a second encoded format, wherein the output video includes at least two segments with different resolutions.

We analyze the content of the video, on a segment by segment basis, to determine if a particular segment is downsample resilient. One embodiment analyzes 150 the segment 117, based on a full-resolution video 144. An alternative embodiment analyzes a bitstream information 146 retrieved from the encoded video.

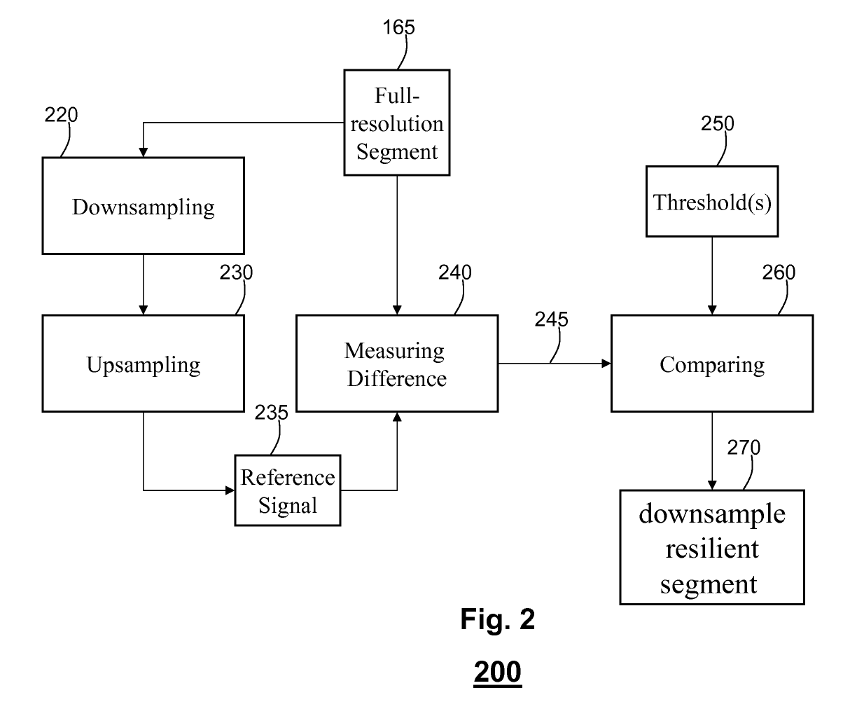

FIG. 2 shows a method 200 for determining the downsample resilient segments 270 based on metrics of the quality of a full-resolution video decoded from the input video 110. The full-resolution segment 165 of the video is first downsampled 220 and than upsampled 230 to produce a reference signal 235, such that a resolution of the reference signal 235 is equal to the resolution of the segment 165. We measure 240 a difference between the reference signal 235 and the full resolution segment 165, and the result of the measurement 245 is compared 260 with a predetermined threshold 250 to identify the segment as a downsample resilient segment 270.

The thresholds 250 can include one threshold, or separate thresholds for horizontal and vertical downsampling, respectively. Furthermore, we can determine optimal downsampling parameters by varying a horizontal scale factor and a vertical scale factor for the downsampling 220.

The measure of difference can be a mean-squared error (MSE) between the reference signal 235 and the input video 110, or a mean-absolute error for the measuring.

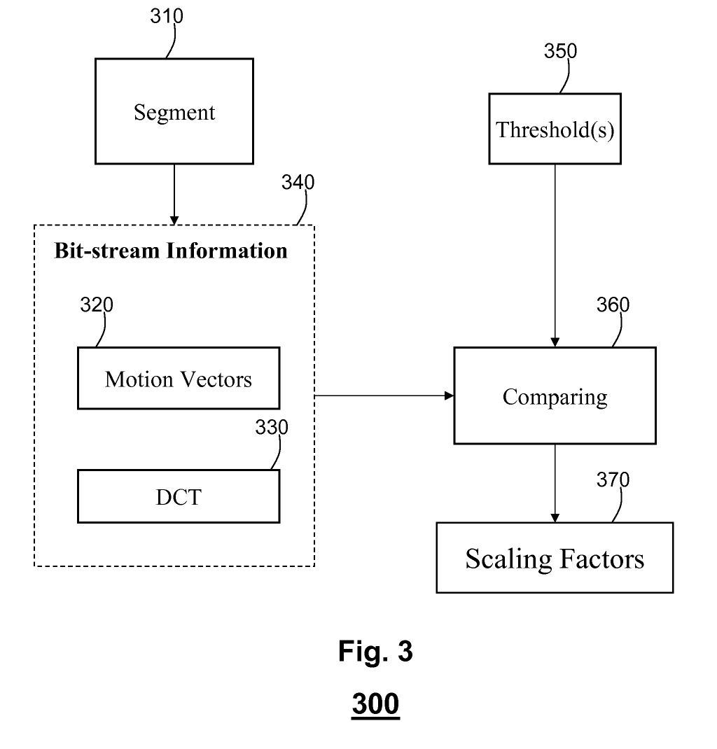

FIG. 3 shows a method 300 for determining the downsample resilient segments based on bitstream information 340 retrieved from the set of segments 115 of an encoded video 110, e.g., a segment 310. The examples of bitstream information 340 are, but not limited to, motion vectors 320 and discrete cosine transform (DCT) coefficients 330.

By analyzing the DCT coefficients extracted from the encoded video, we can determine if the segment 310 is downsample resilient. If most of the high-frequency components from the input bitstream are zero, then there are typically a small number of fine details or sharp edges in the segment, and the segment is more likely to be downsample resilient.

Accordingly, by comparing 360 the bitstream information 340, such as motion vectors 320 or DCT coefficients 330 with thresholds 350, we determine if the segment 310 is the downsample resilient segment. Moreover, by using a variety of thresholds 350, e.g., for vertical and horizontal downsampling of different magnitudes, we can determine scaling factors 370 for the subsequent downsampling. For example, if the magnitude of both the vertical motion vectors and the horizontal motion vectors are less then the predetermined vertical and horizontal thresholds, then the both vertical and horizontal scaling factors are 1, i.e., the segment 310 is not downsample resilient.

If the magnitude of vertical motion vector is greater than the threshold for the vertical scale factor of 2, but less than threshold for the vertical scale factor of 3, then the vertical scaling factor is 2. Similarly, the horizontal scaling factor is determined by comparing the magnitude of the horizontal motion vector with number of the horizontal thresholds. Typically, the scaling factors have magnitudes of powers of two, e.g., 1, 2, 4, 8.

The horizontal scaling factor does not have to be equal to the vertical scaling factor. Furthermore, in one embodiment the horizontal threshold is part of a set of horizontal thresholds, and the vertical threshold is part of a set of vertical thresholds, and each horizontal threshold and each vertical thresholds corresponds to a particular horizontal and vertical scaling factor respectfully.

### EXAMPLES

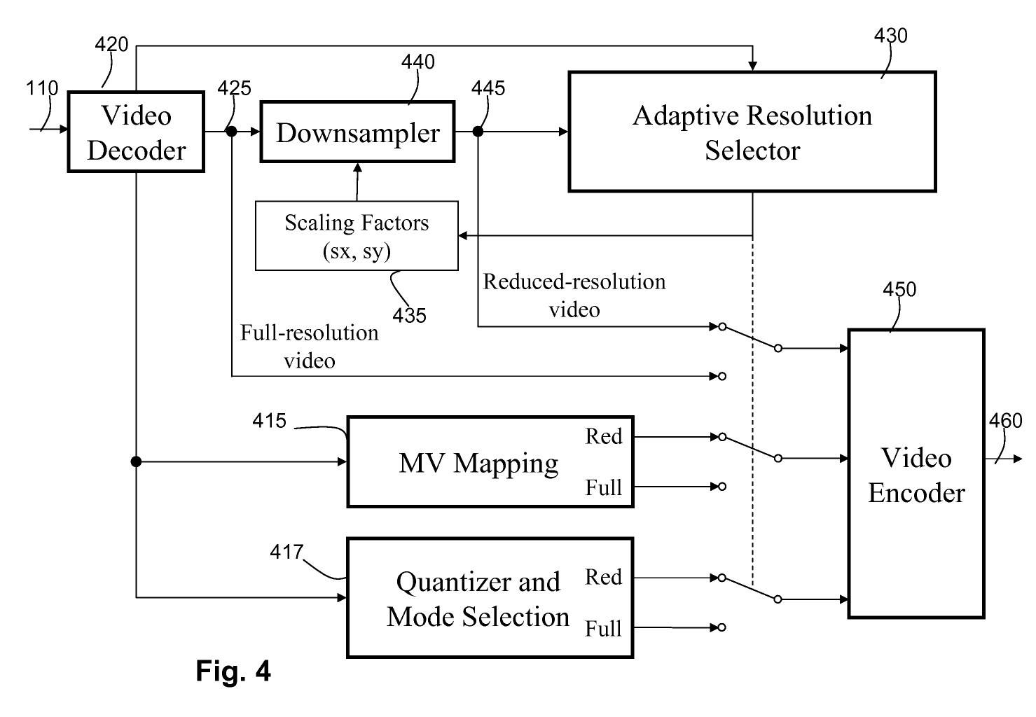

FIG. 4 shows a transcoder according to one embodiment of the invention. The input video bitstream 110 is processed by a video decoder 420 to produce a full-resolution video 425, and macroblock information including motion vectors 415, and coding modes 417.

An adaptive resolution selector 430 determines the pair of resolution scale factors (sx, sy) 435 for both horizontal and vertical directions according to outputs of the video decoder 420. The adaptive resolution selector 430 determines whether the system transcodes the full-resolution video 425 or a reduced resolution video 445, and what the scale factors are in each dimension for downsampling 440. For instance, resolution scale factors of (1, 1) implies full-resolution transcoding, while resolution scale factors of (2, 1) implies horizontal down-sampling by a factor of two and no down-sampling in the vertical direction. The scale factors can have other values, e.g., 3, 4, 3.5. The resolution of the video 445 can change adaptively over time.

The spatial resolution is signaled at certain points in the bitstream. For instance, in the H.264/AVC coding format, the spatial resolution of frames in a coded video sequences is allowed to change at an instantaneous decoding refresh (IDR) picture. A new spatial resolution of frames in a coded video sequence is signaled by the sequence parameter sets (SPS) syntax, as part of an IDR access unit. Similarly, in the MPEG-2 coding format, a change in spatial resolution can be signaled in a sequence header.

When the transcoder adapts the spatial resolution of the current frame and subsequent frames, the system can either wait until the next IDR access unit in the case of H.264/AVC, or the sequence header, in the case of MPEG-2, or transcode the frame in such a way that the change takes effect immediately. A decision for a group of frames or pictures (GOP) also can be made based on the collective set of resolution selections for several frames, including both previous and subsequent frames.

If the reduced resolution is selected, then the full-resolution video 425 is down-sampled 440 by the resolution scaling factors 435. Motion vector mapping is performed according to the resolution scale factors using outputs of the video decoder to yield mapped motion vectors 415. Quantizer and mode selection are also performed according to the resolution scale factors using outputs of the video decoder to yield output quantizers and output coding modes 417.

The video encoder encodes 450 either the full-resolution or reduced resolution video according to the mapped motion vectors, output quantizers, and output coding modes to produce a transcoded output bitstream 460.

Adaptive Resolution Selection Based on Segment Quality

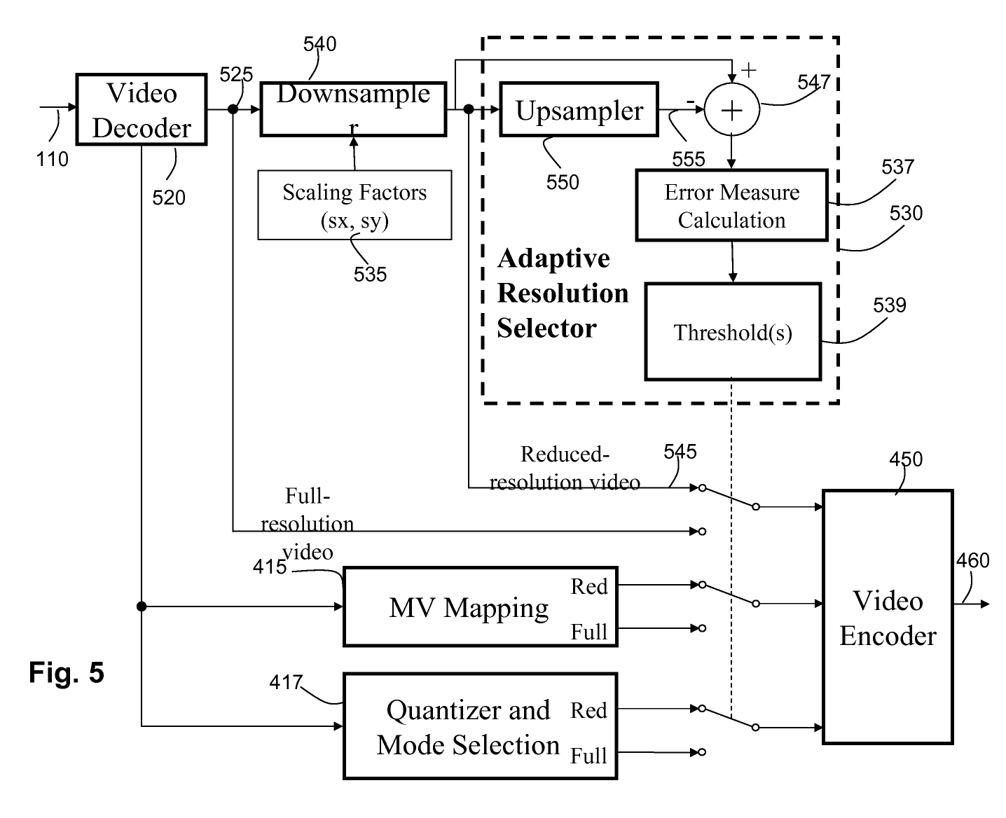

FIG. 5 shows an adaptive-resolution transcoder based on frame quality metrics according to an embodiment of the invention. Each segment of the video bitstream 110, which can be represented as a frame or field, is decoded 520 to a full-resolution video 525 of the segment and downsampled 540 horizontally and/or vertically by the resolution scaling factors 535. The resulting lower-resolution frame 545 is then upsampled 550 and filtered, resulting in a down/up-sampled segment 555 whose resolution matches the originally decoded video 525. The difference 547 between this down/up-sampled frame and the originally decoded frame is taken and then passed to an adaptive resolution selector.

The adaptive resolution selector applies a measure 537 to the difference 547 between the down/up-sampled segment and the originally decoded segment. This measure is compared to a threshold, or a set of thresholds 539. For example, the measure is the MSE. If down/up-sampling the frame does not significantly degrade the image quality, then the MSE is small. Transcoding to a reduced resolution should not significantly degrade the overall frame quality, so the adaptive resolution selector switches to the reduced-resolution mode because the MSE is less than a given threshold. However, if the MSE is greater than the threshold, then the transcoder switches to the full-resolution mode to avoid a significant decrease in frame quality. Other measures based on the difference between the originally decoded frame and the down-up/sampled frame also can be used, e.g., sum of absolute differences (SAD).

After the resolution has been selected, the full or reduced-resolution video frame is passed to the reduced-complexity encoder 450, which uses parameters 415 and 417, mapped from the input bitstream, to produce a transcoded output bitstream 460. The parameters can include motion vectors, macroblock modes, and quantizer information.

Adaptive Resolution Selection Based on Compressed Data

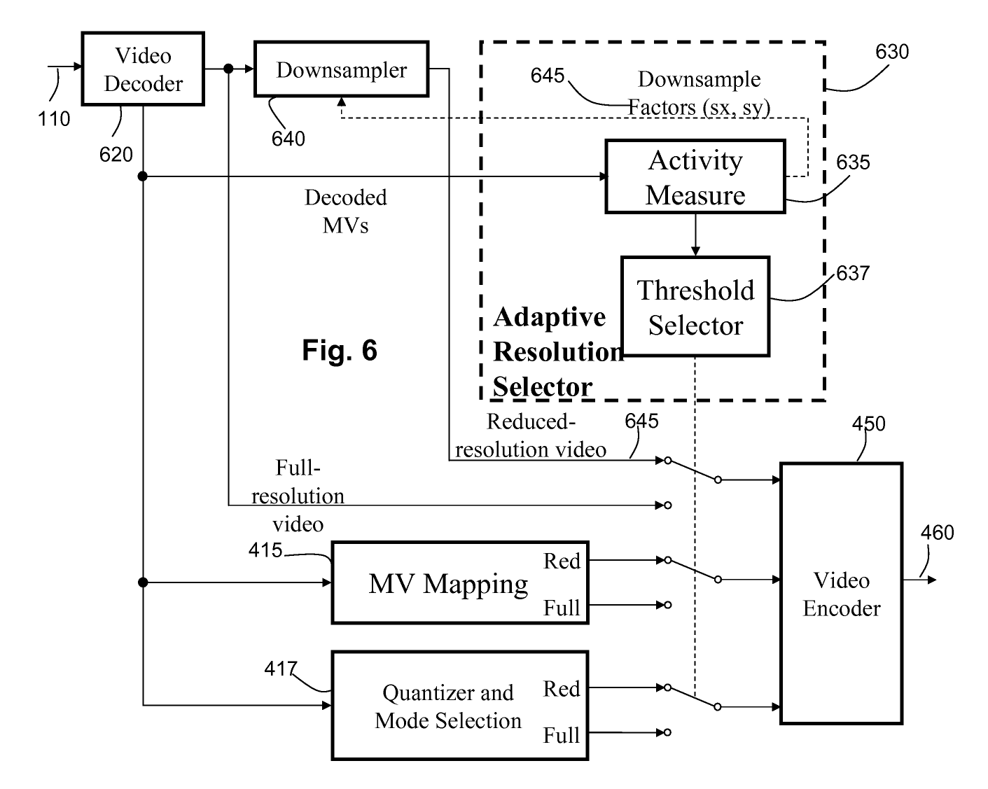

FIG. 6 shows an adaptive-resolution transcoder based on an encoded video 110. In this embodiment, the input to the adaptive resolution selector is data extracted directly from the input video bitstream. This method eliminates the need for up-sampling and differencing, as shown in FIG. 5.

One example of extracted bitstream information that can be used to decide whether to switch to a lower resolution is the magnitude of horizontal and/or vertical motion vectors between frames. If the average magnitude 635 of horizontal motion vectors between two frames is large compared to thresholds 637, then it is likely that the amount of motion between those two frames is large. Because motion typically cause blur when a frame is acquired with a camera, it is likely that pairs of frames with large horizontal motion vector magnitudes degrade less from a down/up-sampling process than pairs of frames with little or no motion. The adaptive resolution switcher can therefore switch to a reduced horizontal resolution mode when the average horizontal motion vector magnitude is above some given threshold. A similar method can be applied to vertical motion vectors.

Another example of an input to the adaptive resolution switcher is the DCT coefficients extracted from the input bitstream. If most of the high-frequency components from the input bitstream are zero, then there are a small number fine details or sharp edges in the corresponding video frame. Therefore, the frame can be transcoded using the lower resolution. If there is a significant amount of high-frequency coefficient activity, then the resolution remains the same. The horizontal and vertical resolution scale factors can be different.

Timing of Resolution Change

In some embodiments, the transcoding is performed according to a mode of the transcoding, e.g., instantaneous, predictive, and delayed modes.

In the instantaneous mode, the adaptive resolution selector analyses the characteristics of the current input frame. If a decision is made to change the resolution, then the frame is immediately transcoded to an instantaneous decoding refresh (IDR) picture, i.e., the downsampled segments are immediately transcoded after the downsampling. However, transcoding too many frames to IDR pictures can reduce coding efficiency.

The instantaneous mode can limit the frequency of changes of the resolution. This mode can restrict the resolution changes only to boundaries of GOP. Because all predicted frames and their corresponding reference frames have the same resolution, resolution changes also can be limited, for example, to I or P input frames to reduce complexity and maintain coding efficiency.

In the predictive mode, the adaptive resolution selector measures characteristics from a series of frames or GOP and uses the characteristics to decide whether to initiate a resolution change on the next GOP. In one embodiment, we measure a characteristic of a current segment in the set of segments and select a next segment into the set of downsample resilient segments based on the characteristic.

Because this decision is made before a GOP is transcoded, the resolution change and transcoding operations can be performed concurrently, thus reducing the complexity and cost.

In the delayed mode, each segment includes frames for a group of pictures (GOP), and characteristics of the frames in the current GOP are buffered and measured. Then, a decision is made whether to change the resolution of the current GOP, or to initiate a change within the GOP using the characteristics of the frames. Although both embodiments can be used in this mode, the second embodiment is more suitable because the activity measure in the adaptive resolution selector does not require frame buffers.

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

We claim:

1. A method for transcoding an input video in a first encoded format to an output video in a second encoded format, wherein the videos include a set of segments and each segment includes at least one frame, comprising a processor for performing steps of the method, comprising the steps of:
determining a set of downsample resilient segments in the input video;
downsampling, adaptively, the set of downsample resilient segments to produce a set of downsampled segments; and
transcoding the input video using the set of downsampled segments to produce the output video including at least two segments with different resolutions.

2. The method of claim 1, wherein the determining further comprising:
modifying a segment of the input video by downsampling and upsampling operations to produce a reference signal;
measuring a difference between the segment and the reference signal; and
selecting the segment as the downsample resilient segment based on the difference and a threshold.

3. The method of claim 1, wherein the determining further comprising:
selecting a segment as the downsample resilient segment based on a result of comparison of a motion vector of the segment with a predetermined threshold.

4. The method of claim 1, further comprising:
comparing discrete cosine transform coefficients extracted from a segment with a threshold; and
selecting the segment as the downsample resilient segment based on the comparing.

5. The method of claim 1, further comprising:
associating each segment in the set of downsample resilient segments with a vertical scaling factor and with a horizontal scaling factor such that the downsampling is performed according to values of the scaling factors.

6. The method of claim 5, wherein the vertical scaling factor equals 1, and the horizontal scaling factor is greater than 1.

7. The method of claim 5, wherein the horizontal scaling factor equals 1, and the vertical scaling factor is greater than 1.

8. The method of claim 5, wherein the horizontal scaling factor equals the vertical scaling factor.

9. The method of claim 5, wherein the horizontal scaling factor differs from the vertical scaling factor.

10. The method of claim 1, wherein each segment in the set of segments has a constant resolution.

11. The method of claim 1, further comprising:
determining a set of full-resolution segments in the input video, wherein the transcoding is further using the set of full-resolution segments.

12. The method of claim 1, wherein the transcoding is performed according to a mode of the transcoding.

13. The method of claim 12, wherein the mode of the transcoding is instantaneous, such that the downsampled segments are immediately transcoded after the downsampling based on characteristics of the current input frame.

14. The method of claim 12, wherein the mode of the transcoding is predictive, wherein the determining further comprising:
measuring a characteristic of a current segment in the set of segments; and
selecting a next segment into the set of downsample resilient segments based on the characteristic.

15. The method of claim 12, wherein each segment includes frames for a group of pictures (GOP), and the mode of the transcoding is delayed, and the determining using characteristics of the frames.

16. An adaptive video transcoder, comprising:
an adaptive resolution selector configured to determine a set of downsample resilient segments in an input video;
a downsampling module configured to adaptively downsample the set of downsample resilient segments to produce a set of downsampled segments; and
a transcoding module configured to transcode the input video using the set of adaptively downsampled segments to produce a output video having at least two segments of different resolution.

17. The adaptive transcoder of claim 16, wherein the adaptive resolution selector is further configured to determine a vertical scaling factor and a horizontal scaling factor for each segment in the set of downsample resilient segments, and wherein the downsampling module is further configured to downsample according to the scaling factors.

18. A method for adaptive video transcoding of an input video in a first encoded format into an output video in a second encoded format, wherein each segment of the input video has a constant resolution, comprising a processor for performing steps of the method, comprising the steps of:
determining a set of downsample resilient segments in the input video; and
transcoding the input video into the output video, such that a resolution of only the set of downsample resilient segments in the output video is reduced.

19. The method of claim 18, the transcoding further comprising:
modifying a segment of the input video by downsampling and upsampling to produce a reference signal;
comparing the segment of the input video with the reference signal to determine scaling factors; and
downsampling the segment of the input video according to the scaling factors.

20. The method of claim 18, wherein the input video includes bitstream information of a segment of the video, further comprising:
determining scaling factors based on the bitstream information of the segment; and
downsampling the segment according to the scaling factors.

21. The method of claim 20, wherein the bitstream information includes a horizontal motion vector and a vertical motion vector, and the scaling factors include a horizontal scale factor and a vertical scale factor, further comprising:
comparing a magnitude of the horizontal motion vector with a horizontal threshold to determine the horizontal scale factor; and
comparing a magnitude of the vertical motion vector with a vertical threshold to determine the vertical scale factor.

22. The method of claim 21, wherein the horizontal threshold is part of a set of horizontal thresholds, and the vertical threshold is part of a set of vertical thresholds, and wherein each horizontal threshold and each vertical thresholds corresponds to a particular horizontal and vertical scaling factor respectfully.

23. The method of claim 20, wherein the bitstream information includes discrete cosine transform (DCT) coefficients, and the determining is based on the DCT coefficients.

24. The method of claim 18, wherein the second encoded format is H.264/AVC.
